(19) United States
(12) Patent Application Publication
(10) Pub. No.: US 2003/0172037 A1
(43) Pub. Date: Sep. 11, 2003

(54) System and method for purchasing and authentificating electronic tickets

(75) Inventors: Changwoo Jung, Seoul (KR); Seongsoo Yim, SongNam (KR); Jaekeun Lee, Seoul (KR)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: International Business Machines Corporation, Armonk, NY

(21) Appl. No.: 10/318,818

(22) Filed: Dec. 13, 2002

(30) Foreign Application Priority Data
Mar. 7, 2002 (KR) 2002-0012109

(51) Int. Cl. G06F 17/60; H04K 1/00; H04L 9/00

(52) U.S. Cl. 705/64

(57) ABSTRACT

A method and system for purchasing and authenticating an electronic ticket has a computer for receiving a ticket request from a user system and generating electronic ticket image data including a ticket identifier in response to the request; encrypting the generated electronic ticket image data and sending them to the user system; forwarding the encrypted electronic ticket image data from the user system to an associated user wireless communication terminal; which decrypts the encrypted electronic ticket image data and displays it on the screen of the terminal; and a computer which checks the validity of the ticket by reading the electronic ticket image data displayed on the screen of the terminal.

### BACKGROUND OF THE INVENTION

1. Field of the Invention

The present invention relates to a system and a method for purchasing and authenticating an electronic ticket, more particularly, to a system and a method capable of forwarding the electronic ticket purchased by an user over an internet to the user wireless communication terminal and authenticating the electronic ticket stored in the wireless communication terminal by using a scanning device.

2. Description of the Prior Art

Here, the term “ticket” includes a giftcard which can purchase various kinds of goods, a discount coupon or a giftcard which is available at a restaurant and so forth as well as an admission ticket for a movie or a play, and means all the tickets, certificates or documents which may substantially have a money function.

According to the method, the user can purchase the ticket in many ways such as a purchase in a typical ticket office, a purchase from a vending machine, a purchase over a telephone, a purchase over a wire internet network, and a purchase over a wireless internet network. In other words, in addition to the purchase in the typical ticket office, any of the various methods for purchasing ticket items from the vending machines, stores, or over wired or wireless internet networks have been introduced for the convenience of the user.

In case of the purchase in the typical ticket office or the purchase from a vending machine, there is a problem in that the user must visit a ticket office or machine in person and purchase the ticket. The purchase over the telephone has a convenience that the user can purchase the ticket without visiting a ticket office, but has a drawback in which the user must go to receive the result of the purchase, i.e., the ticket in the ticket office.

Recently, in the condition in which the internet network is widely spread, the purchase over a wire internet network is widely used. Each of the service providers provides a site for purchasing the ticket over the internet and several portal sites which allow the user to purchase the ticket easily are provided. However, the purchase over the wire internet network has a shortcoming in the method for receiving the purchased ticket. As an alternative to solve the inconvenience, a method for directly delivering a ticket purchased over the wire internet network to the purchaser's home by mail or home delivery service and a method for delivering the electronic ticket prepared by digital data to the purchaser via electronic mail type have been proposed. However, the method using the mail or the home delivery service has a problem that the delivery can be delayed, and the method for delivering the electronic ticket has a problem that the user must copy it in a hard copy by using one's own printing system to allow the electronic ticket to be authenticated in the place at which the ticket is available.

On the other hand, there has been developed recently, a high-speed mobile communication environment which includes any of a number of devices such as a pager through a personal portable telephone or a personal digital assistant (PDA), to the next-generation mobile communication equipment to be introduced hereafter. Additional services capable of being provided over the internet have actively been developed in accordance with the development of wireless terminals. That is, the wireless mobile communication is a means of connecting the network to computers or other devices. The wide popularization of the internet and the development of the mobile communication technique allows a wireless communication terminal to be used as a means for accessing the internet anywhere and anytime. The user can move to a desired place, while still maintaining access to the network. In this condition, a ticketing service by a wireless internet network has been introduced in recent years. However, because of the performance of the portable equipment or the limitation of the equipment itself, there is a limitation that a person familiar with the existing wire internet having vast multimedia information such as an image, a dynamic image, or a voice can not obtain the information having the level of that available on a wire internet from the wireless internet service. In other words, the wireless internet has bandwidth and speed limitations in the interface which slows delivery and rediness of content of information received at the wireless communication terminal and an additional inconvenience in the use thereof in that the communication cost thereof is very much higher than that of the wire internet.

### SUMMARY OF THE INVENTION

Thus, in order to overcome the problems in the reception and the usage of the ticket caused by the limitations of the wireless internet, the object of the present invention is to provide a system for purchasing and authenticating an electronic ticket which system is capable of storing the electronic ticket purchased by using wire internet network or any other means of purchase, in the wireless communication terminal and further authenticating the electronic ticket stored in the wireless communication terminal by a scanning device.

In one aspect of the invention, a method for purchasing and authenticating an electronic ticket comprises the steps of a) receiving a ticket request from a user system and generating electronic ticket image data including a ticket identifier in response to the request; b) encrypting the generated electronic ticket image and identifier data and sending to the user system; c) forwarding the encrypted electronic ticket image and identifier data from the user system to an associated user wireless communication terminal; d) decrypting the encrypted electronic ticket image and identifier data and displaying them on the screen of the terminal; and e) checking the validity of the ticket by reading the electronic ticket image and identifier data displayed on the screen of the terminal.

In another aspect of the invention, a method for purchasing and authenticating an electronic ticket comprises the steps of a) receiving a ticket request from a user system and generating electronic ticket image data including a ticket identifier in response to the request; b) encrypting the generated electronic ticket image and identifier data and sending the encrypted electronic ticket image and identifier data to a user wireless communication terminal associated with the user system; c) decrypting the encrypted electronic ticket image data and displaying them on the screen of the terminal; and d) checking the validity of the ticket by reading the electronic ticket image data displayed on the screen of the terminal.

The step of receiving a ticket request from a user system may be performed over the Internet.

The wireless communication terminal may be either a personal digital assistant(PDA) or mobile telephone or any other sort of wireless communication device.

In another aspect of the invention, a system for purchasing and authenticating an electronic ticket comprises a) means for receiving a ticket request from a user system and generating electronic ticket image data including a ticket identifier data in response to the request; b) means for encrypting the generated electronic ticket image and identifier data and sending them to the user system; c) means for forwarding the encrypted electronic ticket image and identifier data from the user system to an associated user wireless communication terminal; d) means for decrypting the encrypted electronic ticket image and identifier data and displaying them on the screen of the terminal; and e) means for checking the validity of the ticket by reading the electronic ticket image and identifier data displayed on the screen of the terminal.

In still another aspect of the invention, a system for purchasing and authenticating an electronic ticket comprises a) means for receiving a ticket request from a user system and generating electronic ticket image data including a ticket identifier data in response to the request; b) means for encrypting the generated electronic ticket image and identifier data and sending the encrypted electronic ticket image and identifier data to a user wireless communication terminal associated with the user system; c) means for decrypting the encrypted electronic ticket image and identifier data and displaying them on the screen of the terminal; and d) means for checking the validity of the ticket by reading the electronic ticket image and identifier data displayed on the screen of the terminal.

The system for purchasing and authenticating further comprises data storage means for storing the information on the generated ticket including the ticket identifier.

The means for checking the validity of the ticket further comprises means for extracting the ticket identifier from the read electronic ticket image data; and means for checking if the extracted ticket identifier is stored in the store means.

### BRIEF DESCRIPTION OF THE ATTACHED DRAWINGS

FIG. 1 is a schematic diagram illustrating an electronic ticket system according to a preferred embodiment of the present invention.

FIG. 2 is a block diagram illustrating the functions of the components of the electronic ticket system shown in FIG. 1.

FIG. 3 shows an example of database of ticket selling information included in the electronic ticket system shown in FIG. 2.

FIG. 4 is a flowchart illustrating a procedure from a purchasing step to an authenticating step in the electronic ticket system according to the preferred embodiment of the present invention.

FIG. 5 shows an example of a screen which electronic ticket image data is directly forwarded from a ticket server to a wireless communication terminal according to the preferred embodiment of the present invention.

FIG. 6 shows an example which the electronic ticket image data is displayed on the screen of the wireless communication terminal according to the preferred embodiment of the present invention.

### DESCRIPTION OF THE PREFERRED EMBODIMENT

Hereinafter, the embodiments of the present invention will be explained with reference to the accompanying drawings. However, the present invention should not be understood as limited to the specific embodiments thereof.

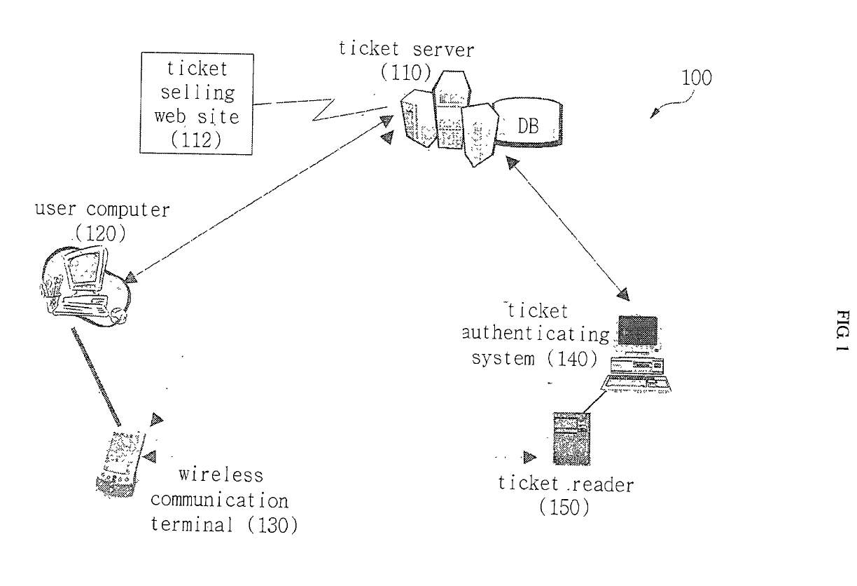

Referring to FIG. 1, a schematic diagram illustrating an electronic ticket system according to the preferred embodiment of the present invention is shown. As shown in FIG. 1, the electronic ticket system 100, according to the preferred embodiment of the present invention comprises a ticket server 110 for managing a ticket selling web site 112, a user system(for example, a user computer 120) connected to the ticket server 110 over a communication network, for example, an internet, a wireless communication terminal 130 capable of accessing the user computer 120 over a wire/wireless network, a ticket authenticating system 140 installed in a place at which a ticket is available, and a ticket reader 150 connected to the ticket authenticating system 140. For convenience of the explanation, one user computer 120 is connected to the ticket server 110 in drawings, but it is obvious that a plurality of user computers can be connected to the ticket server 110.

The ticket selling web site 112 managed by the ticket server 110 allows the user (the web site visitor) to select the electronic ticket related to various products and services such as a movie ticket, a concert ticket, or a train/bus ticket and allows the user to purchase it by various payment methods. The web site may be the web site provided by a specific company and may be the portal web site which functions as a gateway for a plurality of the web sites for selling various electronic tickets. The ticket server 110 manages customer information, and generates electronic ticket image data in response to the customer's ticket request to download them to the user computer 120 or the user wireless communication terminal 130, in association with the management of the ticket selling web site 112.

Basically, the user computer 120 used when the user purchases the ticket on the ticket selling web site 112 is a general personal computer including a memory, a CPU, and an input/output device, and, on the computer, an operating system such as Windows™ and a web browser program such as Internet Explorer™ of Microsoft Corporation or Netscape of Netscape Communication Corporation which allows the user to access to the ticket selling web site. In addition, in order to implement the present invention, a separate application program for downloading the encrypted electronic ticket image data from the ticket server 110 and forwarding them to the user wireless communication terminal 130 by a wire/wireless network is also executed.

The wireless communication terminal 130 can be a cellular phone, a personal digital assistant PDA, or a next-generation mobile communication terminal which can perform wireless communication. In the embodiment of the present invention, the wireless communication terminal 130 downloads the electronic ticket image data from the user computer 120 or the ticket server 110 and displays the downloaded ticket on the screen thereof so as to authenticate the ticket at the place at which a ticket is available.

The ticket authenticating system 140 is installed in the place for which a ticket is available such as the entrance of the theater, and comprises the ticket reader 150 for reading the electronic ticket image displayed on the user wireless communication terminal 130. The ticket authenticating system 140 decodes the electronic ticket image read by the ticket reader 150, reads a ticket barcode, communicates with the ticket server 110 over the communication network, and checks the validity of the ticket.

The ticket reader 150 may be an infrared-ray(IrDA) reader or a POS terminal, and reads the electronic ticket image data displayed on the user PDA and forwards them to the ticket authenticating system 140.

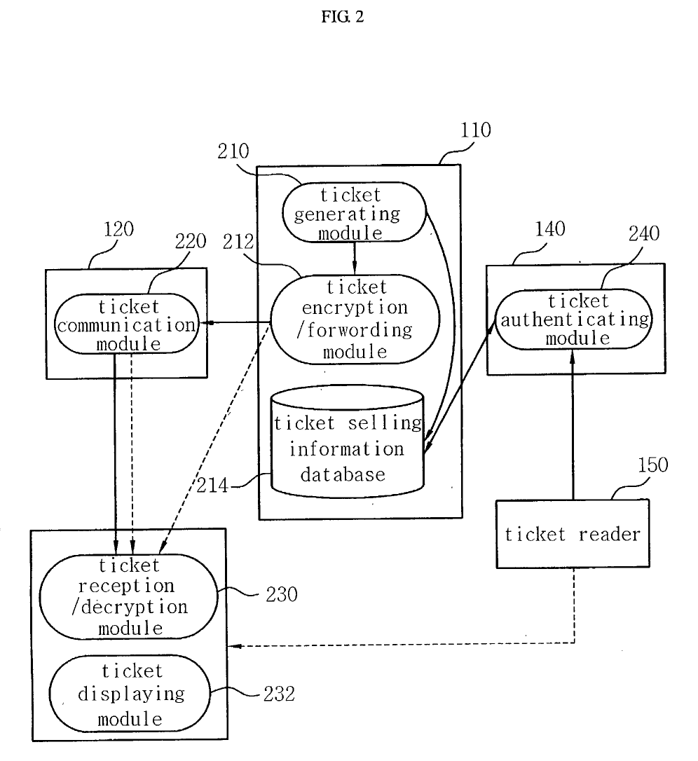

Referring to FIG. 2, the functions of the components in the electronic ticket system in FIG. 1 are shown, respectively.

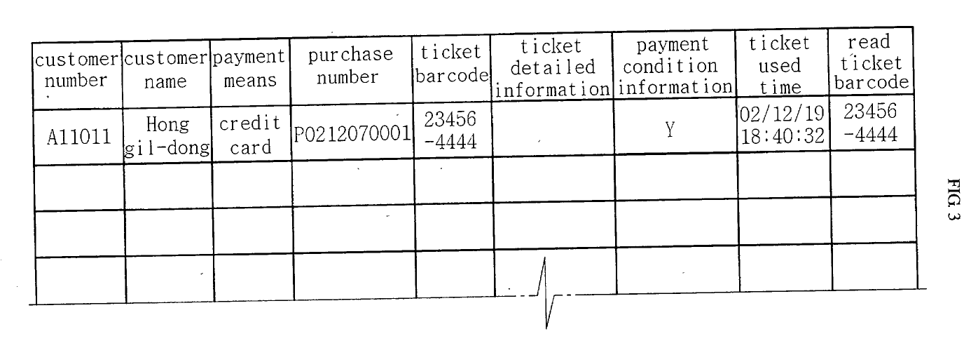

According to the preferred embodiment of the present invention, the ticket server 110 includes a ticket selling information database 214 and executes a ticket generating module 210 and a ticket encryption/forwarding module 212. The ticket generating module 210 generates the electronic ticket in response to the user ticket request (including ticket selection and ticket fee payment) received from the user computer. The ticket generating module 210 generates a barcode as an identifier required for authenticating the electronic ticket and combines it with the corresponding ticket image to generate the electronic ticket. Also, ticket generating module 210 records the information of the customer which purchases the ticket and the purchased barcode information in the ticket selling information database 214. The concrete information recorded in the ticket selling information database 214 will be explained with reference to FIG. 3, hereinafter.

The ticket encryption/forwarding module 212 encodes the electronic ticket image data generated by the ticket generating module 210 and forwards the encoded electronic ticket image data to the user computer 120. In an alternative embodiment, the ticket encryption/forwarding module 212 can directly forward the encoded electronic image data to the user wireless communication terminal 130.

As a method for encoding the electronic ticket image data, various methods can be used, and the ticket encryption/forwarding module 212 encodes the electronic ticket image data in format which the final reception side (the wireless communication terminal) can decrypt and forwards them to the user computer 120 over the wire communication network or directly forwards them to the wireless communication terminal 130 over the wireless communication network.

Generally, the ticket communication module 220 executed on the user computer 120 can be downloaded from the ticket server 10 to the user computer 120 when the user first visits the ticket selling web site over the user computer 120 and applies for admission. The ticket communication module 220 prevents the encoded electronic ticket image data downloaded from the ticket server 110 from being altered and forwards the electronic ticket image data to the wireless communication terminal 130 provided with a ticket reception/decryption module 230. At this time, the electronic ticket data are forwarded to the wireless communication terminal 130 as it is, without being decrypted or stored in the user computer 120.

The ticket reception/decryption module 230 executed in the wireless communication terminal 130 communicates with the ticket communication module 220 of the user computer 120 over the wire/wireless network and then downloads and decrypts the electronic ticket. In an alternative embodiment, the ticket reception/decryption module 230 of the wireless communication terminal 130 may communicate with the ticket encryption/forwarding module 212 of the ticket server 110 over the wireless network to directly download the electronic ticket data therefrom. Also, the ticket reception/decryption module 230 is the program provided to the user from the ticket selling person, and forms a pair with the ticket communication module 220. The ticket reception/decryption module 230 transmits and receives the encoded electronic ticket, and decrypts the encoded electronic ticket image data downloaded from the user computer 120 (or the ticket server 10).

The ticket display module 232 displays the electronic ticket data decrypted by the ticket reception/decryption module 230 on the screen of the wireless communication terminal 130. The electronic ticket data will be displayed on the screen as a ticket image including the barcode. The barcode functions a identifier for identifying the ticket information.

When the user arrives the place for which a ticket is available with the wireless communication terminal 130 including the ticket image, the barcode on the ticket image is read by the ticket reader 150 of the ticket authenticating system 140 installed in the place at which a ticket is to be used. The read ticket image is forwarded to the ticket authenticating module 240. The ticket authenticating module 240 authenticates the read barcode by accessing the ticket selling information database 214 of the ticket server 110. The read barcode is compared with the barcode stored in the ticket selling information database 214, and, if the read barcode is equal to the barcode stored in the ticket selling information database 214, the user's ticket is valid. When the read barcode is checked, the place for which a ticket is intended, the ticket used time, and the read barcode information are recorded in the corresponding electronic ticket entity in the ticket selling information database 214, and the fact that the user used the electronic ticket is shown. By this method, when the authentication for the electronic ticket is finished, the user can be admitted or given the access authorized by the valid ticket.

Referring to FIG. 3, an embodiment of the ticket selling information database 214 shown in FIG. 2 is shown. A “customer number” can be applied to the user as an identification number when the user becomes the member of the ticket selling web site. A “customer name” is the name of the customer, and “payment means” is the method that the user pays the ticket fee. A “purchasing number” is the number for identifying the ticket purchasing order of the customer. A “ticket barcode” is the number for identifying the ticket, and may be included in the electronic ticket image to be used in judging the validity of the ticket hereafter. A “ticket detailed information” is the information for concretely explaining the ticket purchased by the user, and may include, the theater, the movie title, the movie showing time, etc., for example of a movie ticket. A “payment condition information” is the information for confirming whether the user pays the ticket fee or not. A “ticket used time” and a “read ticket barcode” are the information forwarded to the ticket server by the ticket authenticating system when the electronic ticket is actually used in the place at which a ticket is available. Each of the above-mentioned items of the ticket selling information database is only the example, the portion of the items may be deleted or new items may be added, according the concrete embodying method, and these modifications are not a departure from the scope of the present invention.

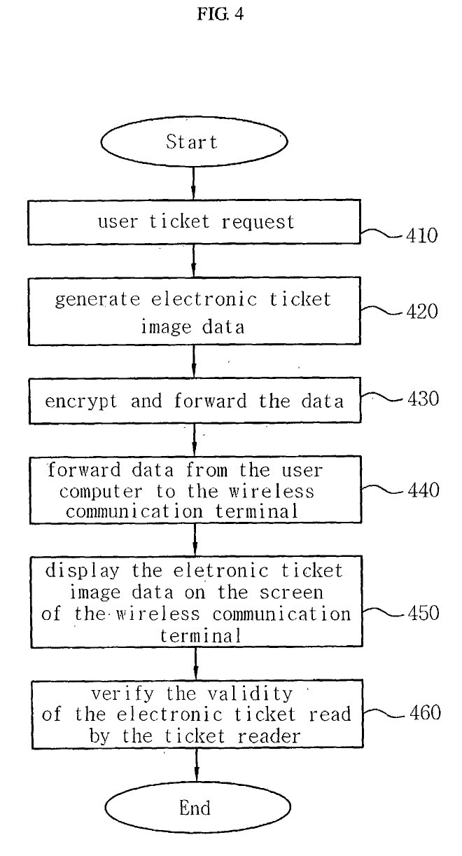

Referring to FIG. 4, a flowchart for illustrating the procedure from a purchasing step to an authenticating step in the electronic ticket system according to the preferred embodiment of the present invention is shown.

In the step 410, after the user accesses to the web site for selling the electronic ticket by using one's own computer, the user requests the purchase of the electronic ticket. The ticket fee payment associated with the electronic ticket purchase can use a credit card or a bank credit system, but are not limited thereto.

In the step 420, the ticket server associated with the ticket selling web site which receives the electronic ticket request from the user generates the electronic ticket image data to be forwarded to the user. According to the preferred embodiment of the present invention, by combining a graphic image of the ticket with the ticket barcode required for authenticating the ticket, the electronic ticket image data is generated.

In the step 430, the generated electronic ticket image data is encrypted in a format that a person which has no the authority therefor can not decrypt or alter and is forwarded to the user computer or is directly forwarded to the user wireless communication terminal. In case where the electronic ticket image data is forwarded to the user computer, the step for forwarding it from the user computer to the wireless communication terminal is added (the step 440). In this case, since the electronic ticket image data is forwarded to the wireless communication terminal as it is, without storing the copy of the data in the user computer, the electronic ticket can be prevented from being used again by the user.

In the step 450, the wireless communication terminal which receives the electronic ticket image data decrypts the encrypted data to restore it in the ticket image form and displays the ticket image data on the screen thereof.

In the step 460, when the user goes to the place for which a ticket is intended with the wireless communication terminal on which the electronic ticket is displayed, the ticket authenticating system installed in the place at which a ticket is available verifies the validity of the ticket by using the barcode read by the ticket reader. According to the preferred embodiment of the present invention, the ticket authenticating system can verify the validity of the ticket by accessing to the ticket server and then searching the database in which the ticket selling information is stored.

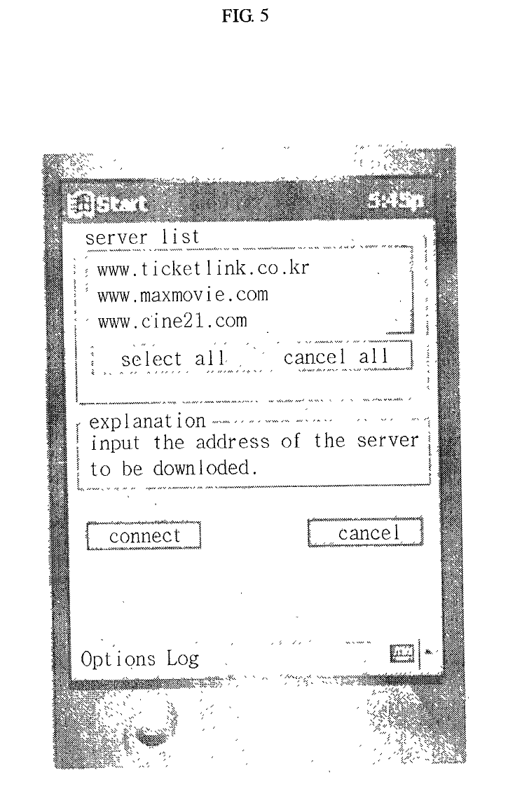

FIG. 5 shows an example of a screen in which electronic ticket image data are directly forwarded from a ticket server to a wireless communication terminal according to the preferred embodiment of the present invention. As shown, the user accesses the corresponding web site by inputting the address of the web site, so that the user purchases the electronic ticket in the ticket selling web site by using one's own computer and then downloads the purchased ticket to the wireless communication terminal. After access of the web site, appropriate authentication procedure is performed and then the electronic ticket image data is downloaded. In order to directly forward the electronic ticket image data from the ticket selling web site to the wireless communication terminal, the wireless communication terminal must include an internet access capability.

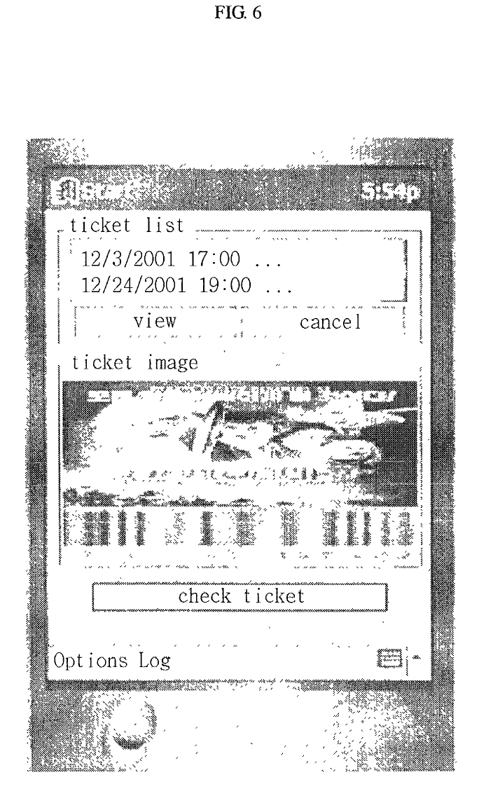

FIG. 6 shows an example which the electronic ticket image data is displayed on the screen of the wireless communication terminal according to the preferred embodiment of the present invention. Similar to FIG. 5, the condition that the downloaded electronic ticket image data are on the screen after the user accesses the ticket selling web site over the wireless communication terminal is shown. The displayed electronic ticket image includes the barcode, and the barcode is read by the ticket reader and is used in verifying the validity of the ticket.

According to the present invention, the user purchases the electronic ticket in the familiar wire internet environment, stores the resultant electronic ticket image data to one's own wireless communication terminal over the wireless communication network, and allows the electronic ticket stored in the wireless communication terminal to be authenticated at the place for which the ticket is intended, thereby the convenience of the user can be promoted, without performing a separate procedure for allowing the user to receive or use the ticket.

Although the present invention has been illustrated and described with respect to exemplary embodiments thereof, the present invention should not be understood as limited to the specific embodiment, and it should be understood by those skilled in the art that the foregoing and various other changes, omission and additions may be made therein and thereto, with departing from the spirit and scope of the present invention.

What is claimed:

1. Method for purchasing and authenticating an electronic ticket, comprising the steps of:
a) receiving a ticket request from a user system and generating an electronic ticket image data including a ticket identifier in response to the request;
b) encrypting the generated electronic ticket image data and sending them to the user system;
c) forwarding the encrypted electronic ticket image data from the user system to an associated user wireless communication terminal;
d) decrypting the encrypted electronic ticket image data and displaying them on the screen of the terminal; and
e) checking the validity of the ticket by reading the electronic ticket image data displayed on the screen of the terminal.

2. Method for purchasing and authenticating an electronic ticket, comprising the steps of:
a) receiving a ticket request from a user system and generating an electronic ticket image data including a ticket identifier in response to the request;
b) encrypting the generated electronic ticket image data and sending the encrypted electronic ticket image data to a user wireless communication terminal associated with the user system;
c) decrypting the encrypted electronic ticket image data and displaying them on the screen of the terminal; and
d) checking the validity of the ticket by reading the electronic ticket image data displayed on the screen of the terminal.

3. The method of either claim 1 or 2, wherein receiving a ticket request from a user system is performed over the Internet.

4. The method of either claim 1 or 2, the wireless communication terminal may be either a personal digital assistant(PDA) or mobile telephone.

5. The method of claim 2, wherein sending the encrypted electronic ticket image data to a user wireless communication terminal is performed over the wireless communication networks.

6. The method of claim 1 or 2, wherein checking the validity of the ticket includes extracting the ticket identifier from the electronic ticket image.

7. System for purchasing and authenticating an electronic ticket, comprising:
a) means for receiving a ticket request from a user system and generating an electronic ticket image data including a ticket identifier in response to the request;
b) means for encrypting the generated electronic ticket image data and sending them to the user system;
c) means for forwarding the encrypted electronic ticket image data from the user system to an associated user wireless communication terminal;
d) means for decrypting the encrypted electronic ticket image data and displaying them on the screen of the terminal; and
e) means for checking the validity of the ticket by reading the electronic ticket image data displayed on the screen of the terminal.

8. System for purchasing and authenticating an electronic ticket, comprising:
a) means for receiving a ticket request from a user system and generating an electronic ticket image data including a ticket identifier in response to the request;
b) means for encrypting the generated electronic ticket image data and sending the encrypted electronic ticket image data to a user wireless communication terminal associated with the user system;
c) means for decrypting the encrypted electronic ticket image data and displaying them on the screen of the terminal; and
d) means for checking the validity of the ticket by reading the electronic ticket image data displayed on the screen of the terminal.

9. The system of either claim 7 or 8, further comprising store means for storing the information on the generated ticket including the ticket identifier.

10. The system of 9, wherein the means for checking the validity of the ticket further comprises:
means for extracting the ticket identifier from the electronic ticket image data; and
means for checking if the extracted ticket identifier is stored in the store means.

11. A computer program product, comprising a computer readable medium in which program instructions are stored, which instructions, when read by a computer, cause the computer to perform the steps of method for purchasing and authenticating an electronic ticket according to any one of claims 1-6.
